(19) United States
(12) Patent Application Publication
(10) Pub. No.: US 2026/0177977 A1
(43) Pub. Date: Jun. 25, 2026

(54) HOROLOGICAL ESCAPEMENT MECHANISM WITH ENHANCED LUBRICATION

(71) Applicant: ETA SA MANUFACTURE HORLOGÈRE SUISSE, Grenchen (CH)

(72) Inventors: Christian RUFENACHT, Bienne (CH); Andres Cabezas Jurin, Yverdon-les-Bains (CH)

(73) Assignee: ETA SA MANUFACTURE HORLOGÈRE SUISSE, Grenchen (CH)

(21) Appl. No.: 19/407,689

(22) Filed: Dec. 3, 2025

(30) Foreign Application Priority Data
Dec. 20, 2024 (EP) 24222273.5

(51) Int. Cl. G04B 15/14

(52) U.S. Cl. CPC G04B 15/14

(57) ABSTRACT

An escapement mechanism (100) including an escapement wheel (1) with teeth (2) extending on either side of a median plane (PM) and including at least two teeth (2) each carrying at least one corner cut (20) connected to the impulse surface (4) on the tooth (2), the corner cuts (20) on two different teeth (2) each having a different geometric spatial orientation relative to the respective impulse surface (4) on the tooth (2) with this corner cut (20). Also, a timepiece, in particular a watch, including such an escapement mechanism (100).

### CROSS REFERENCE TO RELATED APPLICATIONS

This application claims priority to European Patent Application No. 24222273.5 filed Dec. 20, 2024, the entire contents of which are incorporated herein by reference.

### TECHNICAL FIELD OF THE INVENTION

The invention relates to a horological escapement mechanism comprising at least one escapement wheel fitted so as to pivot around an escapement axis and arranged to engage with a pallet comprising an entry pallet stone and an exit pallet stone, or with a mechanism comprising an entry pallet stone and an exit pallet stone, or with a release carrying a lock, or with a notched cylinder comprising an entry lip and an exit lip, said escapement wheel comprising a plurality of teeth extending substantially radially relative to said escapement axis, on either side of a median plane orthogonal to said escapement axis, and each comprising a substantially radial lock surface and a substantially tangential impulse surface running between a point and a heel, said heel delimiting a back opposite said lock surface relative to said tooth.

The invention also relates to a timepiece, in particular a watch, comprising such an escapement mechanism.

The invention relates to the field of escapement mechanisms for timepieces.

### TECHNOLOGICAL BACKGROUND

Lubrication of the mechanism between the oscillator and the train is difficult to ensure over the lifetime of a timepiece. The lubricant must be dispensed in just the right amount, without the slightest excess that would inevitably pollute the entire timepiece mechanism. This mainly involves moving the initial amount of lubricant deposited in the horology movement when it was first manufactured, and dispensing it judiciously over the contact surfaces, whether pivot surfaces or dispensing surfaces. However, it is difficult to effectively lubricate the surfaces of the components involved in counting, balance pivots, pallet forks and lifts, escapement wheel teeth.

### SUMMARY OF THE INVENTION

The invention aims to provide means of improving the lubrication of an escapement mechanism.

To this end, the invention relates to a horological escapement mechanism according to claim 1.

The invention also relates to a timepiece, in particular a watch, comprising such an escapement mechanism.

### BRIEF DESCRIPTION OF THE FIGURES

The purposes, advantages and characteristics will be better understood on reading the following detailed description, with reference to the accompanying figures, in which:

FIG. 1 is a schematic perspective view of an escapement wheel in an escapement mechanism according to the invention, in which some or all of the teeth comprise corner cuts in different directions, on either side of the median plane of the toothing, to improve lubrication;

FIG. 2 is a close-up view of FIG. 1, showing three different types of corner cut;

FIG. 3 is another close-up view of FIG. 1, showing two types of opposite corner cuts relative to the median plane of the toothing, according to a first geometry and a second geometry;

FIG. 4 is a schematic plan view of an example of conventional toothing on an escapement wheel;

FIG. 5 is an elevation view of the escapement wheel in FIG. 1, comprising three different corner cut geometries: the first geometry and the second geometry in FIG. 4, tangential to the impulse surface on the periphery of the escapement wheel, and a third geometry, also visible in FIG. 1 and FIG. 2, substantially parallel to the pivot axis of the escapement wheel;

FIG. 6 is a close-up plan view of a corner cut according to the third geometry;

FIG. 7 is a schematic cross-sectional view through the pivot axis of the escapement wheel of particular tooth profiles, in which the impulse surface on the tooth is rimmed by corner cuts according to the first geometry, or by the second geometry, or by both the first geometry and the second geometry; the vertical position, in the direction of the pivot axis, of the impulse surface varies from tooth to tooth;

FIGS. 8 and 9 illustrate an example of cyclic distribution, over the circumference of the escapement wheel, of the positioning of the teeth in FIG. 7, with an ascending sequence of impulse surfaces, then a return to the lowest level for the following period;

FIG. 9 illustrates, in cross-section, the distribution of the impulse surfaces on the teeth in FIG. 8;

FIG. 10 illustrates another variant similar to FIG. 8, again with the teeth as in FIG. 7, but with alternating ascending and descending sequences;

FIG. 11 illustrates yet another variant of the escapement wheel, in which the impulse surface comprises a substantially tangential slot delimited by inclined surfaces, one according to a first geometry and the other according to the second geometry,

FIG. 12 is a schematic front view of a timepiece, in particular a watch, comprising such an escapement mechanism.

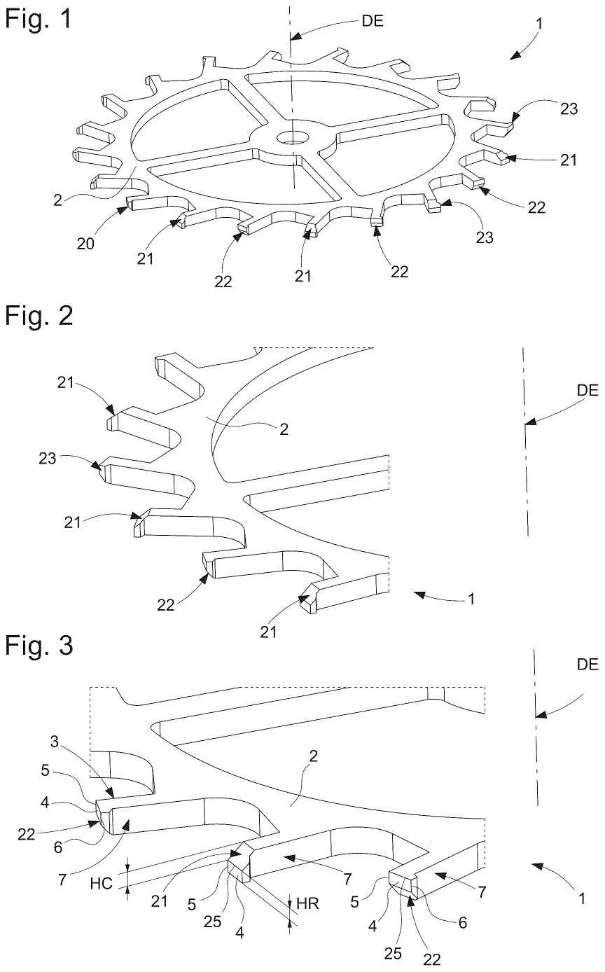

### DETAILED DESCRIPTION OF THE INVENTION

The invention consists of improving the lubrication of the contact between an escapement wheel and a counteracting mechanism such as a pallet or the like.

The invention therefore relates to a horological escapement mechanism 100 comprising at least one escapement wheel 1, which is mounted so as to pivot around an escapement axis DE, and which is arranged to engage with a dispensing mechanism downstream of the oscillator. This dispensing mechanism can comprise, but is not limited to, a pallet comprising an entry lift and an exit lift. This dispensing mechanism can comprise an entry pallet stone and an exit pallet stone or a release carrying a lock, or a notched cylinder comprising an entry lip and an exit lip, or other features.

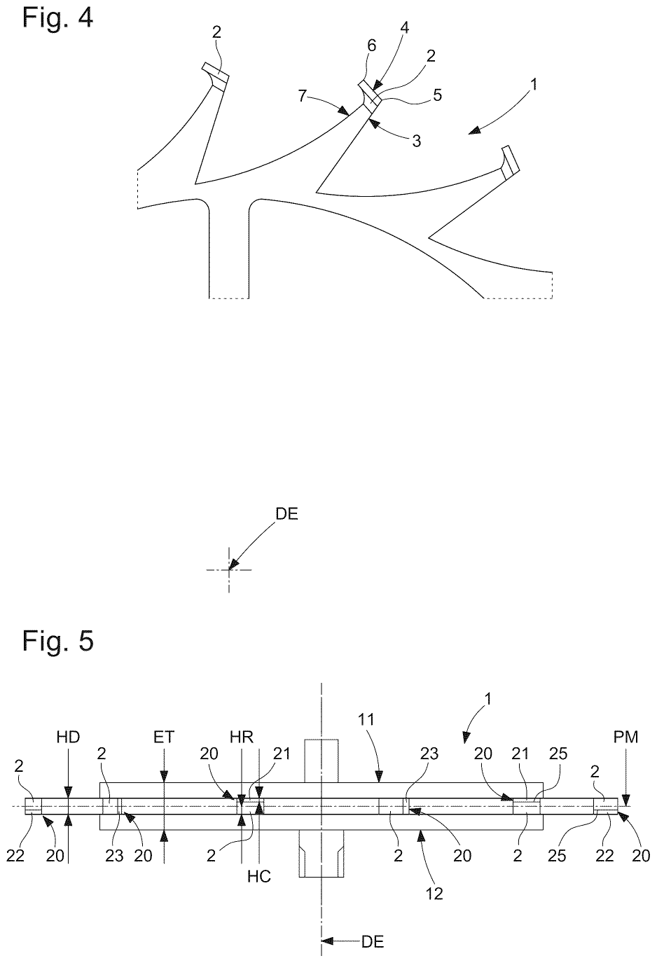

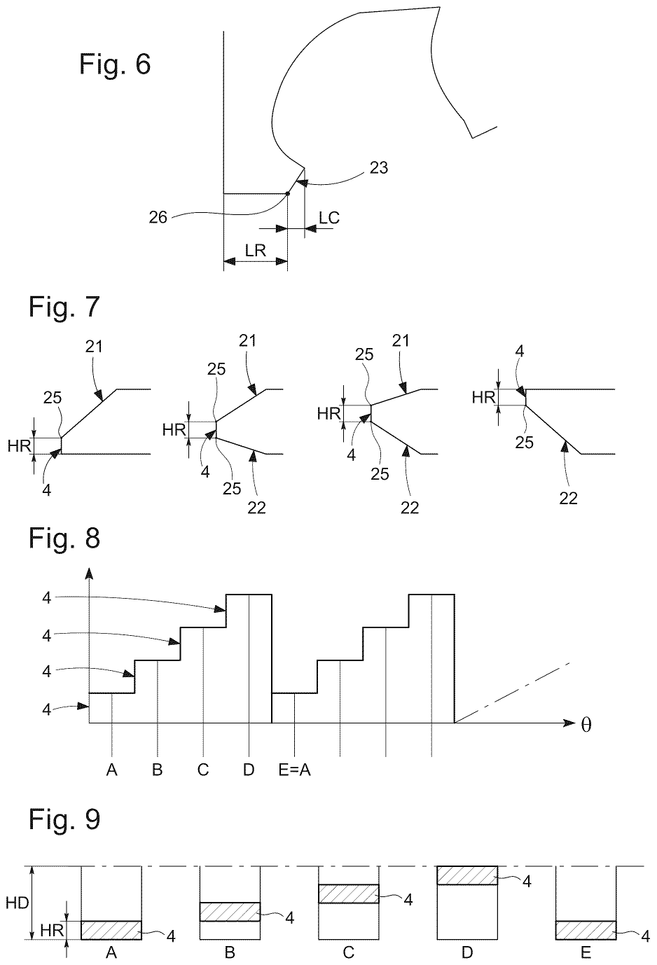

The escapement wheel 1 comprises a plurality of teeth 2, which extend substantially radially relative to the escapement axis DE, on either side of a median plane PM orthogonal to the escapement axis DE. These teeth 2 each comprise a substantially radial lock surface 3 and a substantially tangential impulse surface 4 extending between a point 5 and a heel 6, said heel 6 delimiting a back 7 opposite the lock surface 3 relative to the body of the tooth 2. The point 5 is in contact with the pallet stones on the pallet, as can be seen in FIG. 4.

According to the invention, the escapement wheel 1 comprises at least two teeth 2 each bearing at least one corner cut 20 connected to the impulse surface 4 on the tooth 2. The corner cuts 20 on at least two different teeth 2 each have a different geometric spatial direction relative to the respective impulse surface 4 on the tooth 2 carrying this corner cut 20.

The surface of each corner cut 20 forms an obtuse angle with the impulse surface, allowing drops or micro-droplets of lubricant to pass through easily and remain on the tooth 2 for a long time due to the corner cut.

The different geometric orientation of the corner cuts 20, or even simply their alternance, means that the teeth on the escapement wheel and the opposing lifts or pallets do not always wear in the same place.

A more random positioning of the corner cuts on the periphery of the escapement wheel is therefore advantageous for the long-term durability of the mechanisms.

More specifically, at least one tooth 2 comprises such a corner cut 20 comprising a substantially flat surface in an oblique plane intersecting the escapement axis DE.

More specifically, at least one tooth 2 carrying at least one corner cut 20 comprises a corner cut 20 according to a first geometry 21 that extends towards a first upper side 11 of the escapement wheel 1.

More specifically, at least one tooth 2 carrying at least one corner cut 20 comprises a corner cut 20 according to a second geometry 22 that extends towards a second lower side 12 of the escapement wheel 1.

More specifically, the escapement wheel 1 comprises both at least one tooth 2 carrying at least one corner cut 20, according to the first geometry 21, extending towards a first upper side 11 of the escapement wheel 1, and at least one tooth 2 carrying at least one said corner cut 20, according to the second geometry 22, extending towards a second lower side 12 of the escapement wheel 1.

More specifically, at least one corner cut 20 on a first tooth 2 extends according to the first geometry 21 essentially on a first side of the median plane PM, towards the first upper side 11 of the escapement wheel 1, and at least one corner cut 20 on a second tooth 2 extends according to the second geometry 22 essentially on a second side of the median plane PM, towards the second lower side 11 of the escapement wheel 1.

Even more specifically, at least one corner cut 20 on a first tooth 2 extends according to the first geometry 21 fully on the first side of the median plane PM, towards the first upper side 11 of the escapement wheel 1, and at least one corner cut 20 on a second tooth 2 extends according to the second geometry 22 fully on the second side of the median plane PM, towards the second lower side 11 of the escapement wheel 1.

More specifically, at least one tooth 2 comprises at least one corner cut 20 according to the first geometry 21 or according to the second geometry 22, connected to the impulse surface 4, and that delimits a first edge 25 that is substantially circular and is located in a plane perpendicular to the escapement axis DE.

More specifically, said corner cut 20 extends, projected in the direction of the escapement axis DE, over a corner cut height HC comprised between 50% and 66% of the projection of the remaining height HR of the impulse surface 4.

More specifically, at least one tooth 2 comprises a corner cut 20 that extends along the third geometry 23. This third geometry can extend on either side of the median plane PM and comprise a substantially flat surface in a plane substantially parallel, or parallel, to the escapement axis DE, or extend over the entire tooth height HD of the tooth 2 comprising the corner cut 20, in the direction of the escapement axis DE, or extend in connection with the impulse surface 4 and delimit a second rear edge 26 which is substantially straight and located in a plane substantially parallel, or parallel, to the escapement axis DE. The geometric extension of this corner cut 23 can either meet a tooth 2 other than the tooth 2 carrying the obtuse corner cut 23 forming an obtuse angle with the impulse surface 4, or meet the tooth 2 carrying the acute corner cut 23. More specifically, the escapement wheel 1 comprises both at least one tooth 2 carrying a re-entrant acute corner cut 23, the geometric extension of which meets the tooth 2 carrying the corner cut 20, and at least one tooth 2 carrying an obtuse corner cut 23, the geometric extension of which meets a tooth 2 other than the tooth 2 carrying the corner cut 20.

Even more specifically, the corner cut 23 extends, in a flat projection in the direction of the escapement axis DE on a plane parallel to the median plane PM, over a corner cut width LC less than the projection of the resulting width LR of the impulse surface 4, this resulting width LR must be large, in order to have a sufficiently long second impulse phase.

FIG. 7 schematically illustrates a variant in which the teeth 2 have particular profiles, and in which the impulse surface 4 on the tooth 2 is rimmed by corner cuts according to the first geometry 21, such as guide mark A, or by the second geometry 22, such as guide mark D, or by both the first geometry 21 and the second geometry 22, such as guide marks B and C; the vertical position, in the direction of the pivot axis DE, of the impulse surface 4 is variable according to the type of tooth, so that guide marks B and C have impulse surfaces 4 that are vertically offset from each other.

FIGS. 8 and 9 illustrate an example of cyclic distribution, over the circumference of the escapement wheel, of the positioning of the teeth A, B, C, D in FIG. 7, with an ascending sequence of impulse surfaces 4, then a return to the lowest level for the following period. Cross-sections A, B, C, D and E in FIG. 9 show the position of the impulse surface 4 in each step compared with the tooth height HD.

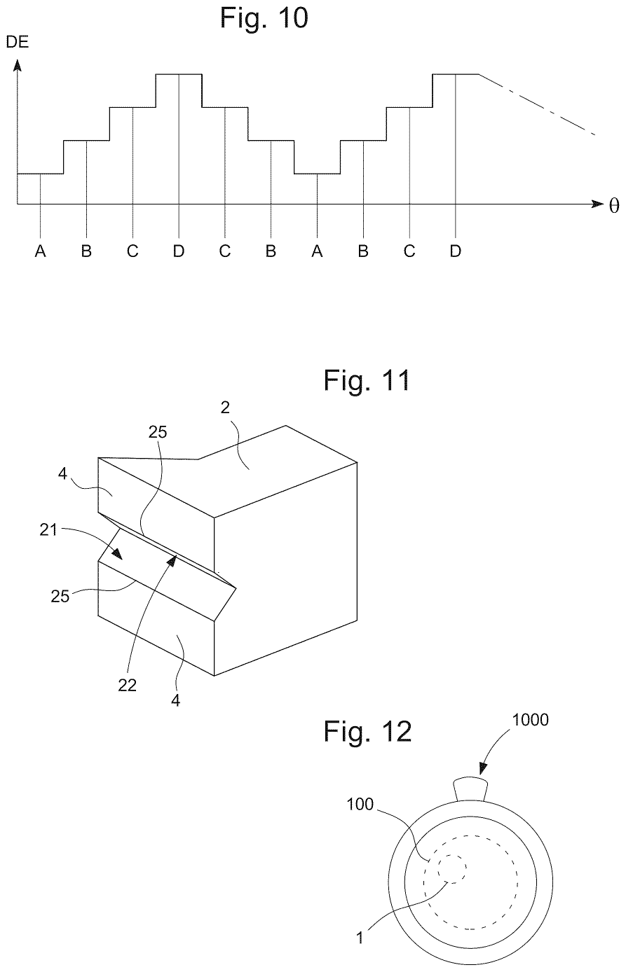

FIG. 10 illustrates another variant similar to FIG. 8, again with the teeth as in FIG. 7, but with alternating ascending and descending sequences.

FIG. 11 illustrates yet another variant of the escapement wheel, in which the impulse surface comprises a substantially tangential slot delimited by inclined surfaces, one according to the first geometry 21 and the other according to the second geometry 22, which is equivalent to two separate impulse surfaces. In particular, the slot can vary in height and depth to improve lubrication.

More specifically, at least one tooth 2 comprises a corner cut 20 with a flat surface.

More specifically, each tooth 2 comprising a corner cut 20 comprises a corner cut 20 with a flat surface.

More specifically, at least one tooth 2 comprises a corner cut 20 with a concave surface.

More specifically, each tooth 2 comprising a corner cut 20 comprises a corner cut 20 with a concave surface.

More specifically, at least one tooth 2 comprises a corner cut 20, with a surface that is microstriated or comprises at least one microcavity, and which is designed to hold a lubricant.

More specifically, the escapement wheel 1 comprises a plate with a total thickness ET in the direction of said escapement axis DE that is greater than the tooth height HD of each said tooth 2 in the direction of said escapement axis DE.

More specifically, the geometries of the corner cuts 20 are aperiodic around the periphery of the escapement wheel 1.

More specifically, at least one tooth 2 comprises at least one oil sink 30 in the vicinity of said impulse surface 4.

More specifically, at least one tooth 2 comprises at least one corner cut 20 connected to said impulse surface 4 and at least one oil sink 30 in the vicinity of said at least one corner cut 20.

More specifically, each corner cut has a surface finish comprised between 0.05 micrometres Ra and 0.8 micrometres Ra.

More specifically the escapement wheel 1 comprises an even number of teeth 2.

The invention also relates to a timepiece 1000, in particular a watch, comprising such an escapement mechanism 100.

The invention lends itself well to conventional machining of horological escapement wheels, and with minimal additional machining costs, ensures improved longevity of the escapement mechanism.

1. A horological escapement mechanism (100) comprising at least one escapement wheel (1) fitted so as to pivot around an escapement axis (DE) and arranged to engage with a pallet comprising an entry pallet stone and an exit pallet stone, or with a mechanism comprising an entry pallet stone and an exit pallet stone, or with a release carrying a lock, or with a notched cylinder comprising an entry lip and an exit lip, said escapement wheel (1) comprising a plurality of teeth (2) extending substantially radially relative to said escapement axis (DE), on either side of a median plane (PM) orthogonal to said escapement axis (DE), and each comprising a substantially radial lock surface (3) and a substantially tangential impulse surface (4) running between a point (5) and a heel (6), said heel delimiting a back (7) opposite said lock surface (3) relative to said tooth (2),
wherein said escapement wheel (1) comprises at least two teeth (2) each carrying at least one corner cut (20) connected to said impulse surface (4), said corner cuts (20) on at least two said different teeth (2) each having a different geometric spatial orientation relative to the respective impulse surface (4) on said tooth (2) carrying said corner cut (20).

2. The horological escapement mechanism (100) according to claim 1, wherein at least one said tooth (2) comprises a said corner cut (20) which comprises a substantially flat surface in an oblique plane intersecting said escapement axis (DE).

3. The horological escapement mechanism (100) according to claim 1, wherein at least one said tooth (2) carrying at least one said corner cut (20) comprises a corner cut (20) that extends towards a first upper side (11) of said escapement wheel (1).

4. The horological escapement mechanism (100) according to claim 1, wherein at least one said tooth (2) carrying at least one said corner cut (20) comprises a corner cut (20) that extends towards a second lower side (12) of said escapement wheel (1).

5. The horological escapement mechanism (100) according to claim 3, wherein said escapement wheel (1) comprises both at least one said tooth (2) carrying at least one said corner cut (20) extending towards a first upper side (11) of said escapement wheel (1), and at least one said tooth (2) carrying at least one said corner cut (20) extending towards a second lower side (12) of said escapement wheel (1).

6. The horological escapement mechanism (100) according to claim 5, wherein at least one said corner cut (20) on a first tooth (2) extends according to a first geometry (21) essentially on a first side of said median plane (PM), towards said first upper side (11) of said escapement wheel (1), and in that at least one said corner cut (20) on a second tooth (2) extends according to a second geometry (22) essentially on a second side of said median plane (PM), towards said second lower side (11) of said escapement wheel (1).

7. The horological escapement mechanism (100) according to claim 5, wherein at least one tooth (2) comprises at least one corner cut (20) according to said first geometry (21) or said second geometry (22), connected to said impulse surface (4), and which delimits a first substantially circular edge (25) located in a plane perpendicular to said escapement axis (DE).

8. The horological escapement mechanism (100) according claim 2, wherein said corner cut (20) projects in the direction of said escapement axis (DE) over a corner cut height (HC) comprised between 50% and 66% of the projection of the remaining height (HR) of said impulse surface (4).

9. The horological escapement mechanism (100) according claim 1, wherein at least one said tooth (2) comprises a said corner cut (20) that extends according to a third geometry (23) on either side of said median plane (PM) and that comprises a substantially flat surface in a plane parallel to said escapement axis (DE).

10. The horological escapement mechanism (100) according to claim 9, wherein at least one said tooth (2) comprises a said corner cut (20) that extends according to a third geometry (23) over the entire tooth height (HD) of the said tooth (2) comprising the said corner cut (20), in the direction of said escapement axis (DE).

11. The horological escapement mechanism (100) according to claim 9, wherein at least one tooth (2) comprises at least one corner cut (20) according to said third geometry (23), connected to said impulse surface (4), and which delimits a second substantially straight rear edge (26) located in a plane parallel to said escapement axis (DE).

12. The horological escapement mechanism (100) according to claim 1, wherein at least one of said teeth (2) comprises a said corner cut (20) that comprises at least one sloping surface comprising gradations.

13. The horological escapement mechanism (100) according to claim 1, wherein at least one said tooth (2) comprises a said impulse surface (4) which comprises a substantially tangential slot delimited by inclined surfaces.

14. The horological escapement mechanism (100) according to claim 1, wherein at least one of said teeth (2) comprises a said corner cut (20) with a flat surface.

15. The horological escapement mechanism (100) according to claim 1, wherein at least one of said teeth (2) comprises a said corner cut (20) with a concave surface.

16. The horological escapement mechanism (100) according to claim 1, wherein at least one of said teeth (2) comprises a said corner cut (20) with a surface that is microstriated or comprises at least one microcavity, and which is designed to hold a lubricant.

17. The horological escapement mechanism (100) according to claim 1, wherein said escapement wheel (1) comprises a plate with a total thickness (ET) in the direction of said escapement axis (DE) that is greater than the tooth height (HD) of each said tooth (2) in the direction of said escapement axis (DE).

18. The horological escapement mechanism (100) according to claim 1, wherein the geometries of said corner cuts (20) are aperiodic on the periphery of said escapement wheel (1).

19. The horological escapement mechanism (100) according to claim 1, wherein at least one tooth (2) comprises at least one oil sink (30) in the vicinity of said impulse surface (4).

20. The horological escapement mechanism (100) according to claim 19, wherein at least one tooth (2) comprises at least one corner cut (20) connected to said impulse surface (4) and at least one oil sink (30) in the vicinity of said at least one corner cut (20).

21. The horological escapement mechanism (100) according to claim 1, wherein each said corner cut has a surface finish comprised between 0.05 micrometres Ra and 0.8 micrometres Ra.

22. The horological escapement mechanism (100) according to claim 1, wherein said escapement wheel (1) comprises an even number of said teeth (2).

23. A timepiece (1000) comprising at least one horological escapement mechanism (100) according to claim 1.
